(19) United States
(12) Patent Application Publication
(10) Pub. No.: US 2024/0381059 A1
(43) Pub. Date: Nov. 14, 2024

(54) SEMANTIC COMMUNICATION TRANSMISSION METHOD AND TERMINAL DEVICE

(71) Applicant: GUANGDONG OPPO MOBILE TELECOMMUNICATIONS CORP., LTD., Dongguan (CN)

(72) Inventor: Wenqiang TIAN, Dongguan (CN)

(21) Appl. No.: 18/782,367

(22) Filed: Jul. 24, 2024

Related U.S. Application Data
(63) Continuation of application No. PCT/CN2022/074351, filed on Jan. 27, 2022.

(51) Int. Cl. H04W 4/12; H04W 24/02

(52) U.S. Cl. CPC H04W 4/12; H04W 24/02

(57) ABSTRACT

This application relates to a semantic communication transmission method and a terminal device. The method includes: performing, by the terminal device, semantic acquisition processing on an information source to obtain semantic information; determining, by the terminal device based on the semantic information, first information to be transmitted; and sending, by the terminal device, the first information.

### CROSS-REFERENCE TO RELATED APPLICATIONS

This application is a continuation of International Application No. PCT/CN2022/074351, filed on Jan. 27, 2022, the disclosure of which is hereby incorporated by reference in its entirety.

### TECHNICAL FIELD

This application relates to the communications field, and more specifically, to a semantic communication transmission method and a terminal device.

### BACKGROUND

Communication transmission aims to implement lossless transmission of original information. However, only the lossless transmission of the original information is merely a basic requirement, not all requirements for communication transmission. More information needs to be transmitted to meet constantly updated communication requirements.

### SUMMARY

Embodiments of this application provide a semantic communication transmission method and a terminal device.

An embodiment of this application provides a semantic communication transmission method, applied to a terminal device and including:
performing, by the terminal device, semantic acquisition processing on an information source to obtain semantic information;
obtaining, by the terminal device based on the semantic information, first information to be transmitted; and
sending, by the terminal device, the first information.

An embodiment of this application provides a semantic communication transmission method, applied to a terminal device and including:
receiving, by the terminal device, second information;
restoring, by the terminal device, an information source from the second information; and
performing, by the terminal device, semantic acquisition processing on the information source to obtain semantic information.

An embodiment of this application provides a semantic communication transmission method, applied to a network device and including:
receiving, by the network device, first information; and
restoring, by the network device, semantic information from the first information,
where the semantic information is information obtained by performing semantic acquisition processing on an information source on the side of a terminal device.

An embodiment of this application provides a semantic communication transmission method, applied to a network device and including:
determining, by the network device based on an information source, second information to be transmitted, where the information source includes semantic information on which semantic acquisition processing is to be performed; and
sending, by the network device, the second information.

An embodiment of this application provides a terminal device, including:
a first semantic acquiring unit, configured to perform semantic acquisition processing on an information source to obtain semantic information;
a first processing unit, configured to obtain, based on the semantic information, first information to be transmitted; and
a first sending unit, configured to send the first information.

An embodiment of this application provides a terminal device, including:
a first receiving unit, configured to receive second information;
a second processing unit, configured to restore an information source from the second information; and
a second semantic acquiring unit, configured to perform semantic acquisition processing on the information source to obtain semantic information.

An embodiment of this application provides a network device. The network device includes:
a second receiving unit, configured to receive first information; and
a third processing unit, configured to restore semantic information from the first information,
where the semantic information is information obtained by performing semantic acquisition processing on an information source on the side of a terminal device.

An embodiment of this application provides a network device. The network device includes:
a fourth processing unit, configured to determine, based on an information source, second information to be transmitted, where the information source includes semantic information on which semantic acquisition processing is to be performed; and
a second sending unit, configured to send the second information.

An embodiment of this application provides a terminal device, including a processor and a memory. The memory is configured to store a computer program, and the processor is configured to invoke and run the computer program stored in the memory, to cause the terminal device to execute the method according to an embodiment of this application.

An embodiment of this application provides a network device, including a processor and a memory. The memory is configured to store a computer program, and the processor is configured to invoke and run the computer program stored in the memory, to cause the network device to execute the method according to an embodiment of this application.

An embodiment of this application provides a chip, configured to implement the method according to an embodiment of this application.

Specifically, the chip includes a processor, configured to invoke a computer program from a memory and run the computer program, to cause a device installed with the chip to execute the method according to an embodiment of this application.

An embodiment of this application provides a computer-readable storage medium, configured to store a computer program. The computer program, when run by a device, causes the device to execute the method according to an embodiment of this application.

An embodiment of this application provides a computer program product, including computer program instructions. The computer program instructions cause a computer to execute the method according to an embodiment of this application.

An embodiment of this application provides a computer program. The computer program, when run on a computer, causes the computer to execute the method according to an embodiment of this application.

In the embodiments of this application, a terminal device may perform semantic acquisition processing on an information source to obtain semantic information. The terminal device may determine, based on the semantic information, first information to be transmitted. As a transmit end, the terminal device may send the first information to a receive end.

### BRIEF DESCRIPTION OF DRAWINGS

FIG. 1 is a schematic diagram of an application scenario according to an embodiment of this application.

FIG. 2 is a schematic flowchart of a semantic communication transmission method according to an embodiment of this application.

FIG. 3 is a schematic flowchart of a semantic communication transmission method according to an embodiment of this application.

FIG. 4 is a schematic flowchart of a semantic communication transmission method according to an embodiment of this application.

FIG. 5 is a schematic flowchart of a semantic communication transmission method according to an embodiment of this application.

FIG. 6 is a schematic flowchart of a semantic communication transmission method according to an embodiment of this application.

FIG. 7 is a schematic flowchart of a semantic communication transmission method according to an embodiment of this application.

FIG. 8 is a schematic flowchart of a semantic communication transmission method according to an embodiment of this application.

FIG. 9 is a schematic flowchart of a semantic communication transmission method according to an embodiment of this application.

FIG. 10 is a schematic flowchart of a semantic communication transmission method according to an embodiment of this application.

FIG. 11 is a schematic flowchart of a semantic communication transmission method according to an embodiment of this application.

FIG. 12 is a schematic diagram of schematic coding and decoding in an example of a semantic communication transmission method according to an embodiment of this application.

FIG. 13 is a schematic diagram of a schematic neural network in an example of a semantic communication transmission method according to an embodiment of this application.

FIG. 14 is a schematic diagram of a schematic inter-information relationship in an example of a semantic communication transmission method according to an embodiment of this application.

FIG. 15 is a schematic diagram of schematic coding and decoding in an example of a semantic communication transmission method according to an embodiment of this application.

FIG. 16 is a schematic diagram of schematic extended semantic acquisition in an example of a semantic communication transmission method according to an embodiment of this application.

FIG. 17 is a schematic diagram of schematic extended semantic transmission in an example of a semantic communication transmission method according to an embodiment of this application.

FIG. 18 is a schematic diagram of schematic core semantic acquisition in an example of a semantic communication transmission method according to an embodiment of this application.

FIG. 19 is a schematic diagram of schematic core semantic transmission in an example of a semantic communication transmission method according to an embodiment of this application.

FIG. 20 is a schematic diagram of schematic combined semantic transmission in an example of a semantic communication transmission method according to an embodiment of this application.

FIG. 21 is a schematic diagram of schematic coding and decoding in an example of a semantic communication transmission method according to an embodiment of this application.

FIG. 22 is a schematic diagram of schematic extended semantic transmission in an example of a semantic communication transmission method according to an embodiment of this application.

FIG. 23 is a schematic diagram of schematic core semantic transmission in an example of a semantic communication transmission method according to an embodiment of this application.

FIG. 24 is a schematic diagram of schematic combined semantic transmission in an example of a semantic communication transmission method according to an embodiment of this application.

FIG. 25 is a schematic block diagram of a terminal device according to an embodiment of this application.

FIG. 26 is a schematic block diagram of a terminal device according to an embodiment of this application.

FIG. 27 is a schematic block diagram of a network device according to an embodiment of this application.

FIG. 28 is a schematic block diagram of a network device according to an embodiment of this application.

FIG. 29 is a schematic block diagram of a communications device according to an embodiment of this application.

FIG. 30 is a schematic block diagram of a chip according to an embodiment of this application.

FIG. 31 is a schematic block diagram of a communications system according to an embodiment of this application.

### DESCRIPTION OF EMBODIMENTS

The following describes the technical solutions in embodiments of this application in combination with the accompanying drawings in embodiments of this application.

The technical solutions in embodiments of this application may be applied to various communications systems, for example, a global system for mobile communication (GSM), a code division multiple access (CDMA) system, a wideband code division multiple access (WCDMA) system, general packet radio service (GPRS), a long term evolution (LTE) system, an advanced long term evolution (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunications system (UMTS), a wireless local area network (WLAN), wireless fidelity (WiFi), a fifth-generation (5G) system, or another communications system.

Generally, a quantity of connections supported by a conventional communications system is limited and is also easy to implement. However, with development of communication technologies, a mobile communications system not only supports conventional communication, but also supports, for example, device-to-device (D2D) communication, machine to machine (M2M) communication, machine type communication (MTC), vehicle to vehicle (V2V) communication, or vehicle to everything (V2X) communication. Embodiments of this application may also be applied to these communications systems.

Optionally, a communications system in embodiments of this application may be applied to a carrier aggregation (CA) scenario, a dual connectivity (DC) scenario, or a standalone (SA) networking scenario.

Optionally, a communications system in embodiments of this application may be applied to an unlicensed spectrum, and the unlicensed spectrum may also be considered as a shared spectrum. Alternatively, a communications system in embodiments of this application may be applied to a licensed spectrum, and the licensed spectrum may also be considered as a non-shared spectrum.

Embodiments of this application are described with reference to a network device and a terminal device. The terminal device may also be referred to as user equipment (UE), an access terminal, a user unit, a user station, a mobile site, a mobile station, a remote station, a remote terminal, a mobile device, a user terminal, a terminal, a wireless communications device, a user agent, a user apparatus, or the like.

The terminal device may be a station (ST) in a WLAN, a cellular phone, a cordless phone, a session initiation protocol (SIP) phone, a wireless local loop (WLL) station, a personal digital assistant (PDA) device, a handheld device with a wireless communication function, a computing device or another processing device connected to a wireless modem, a vehicle-mounted device, a wearable device, a terminal device in a next-generation communications system such as an NR network, a terminal device in a future evolved public land mobile network (PLMN), or the like.

In embodiments of this application, the terminal device may be deployed on land, including being indoors or outdoors, may be handheld, wearable, or vehicle-mounted. The terminal device may be deployed on water (for example, on a ship), or may be deployed in the air (for example, on an airplane, an air balloon, or a satellite).

In embodiments of this application, the terminal device may be a mobile phone, a tablet computer (Pad), a computer with a wireless transceiver function, a virtual reality (VR) terminal device, an augmented reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, or a wireless terminal device in smart home, or the like.

By way of example rather than limitation, in embodiments of this application, the terminal device may alternatively be a wearable device. The wearable device may also be referred to as an intelligent wearable device, and is a general term for wearable devices such as glasses, gloves, watches, clothes, and shoes that are intelligently designed and developed based on daily wearing by using a wearable technology. The wearable device is a portable device that can be directly worn or integrated into clothes or accessories of a user. In addition to being a hardware device, the wearable device can also realize various functions through software support, data interaction, and cloud interaction. In a broad sense, wearable smart devices may include a full-featured and large-sized device that can provide full or partial functions without relying on a smart phone, for example, a smart watch or smart glasses, and devices that only focus on a specific type of application function and need to cooperate with another device such as a smart phone for use, for example, various smart bracelets and smart jewelries for physical sign monitoring.

In embodiments of this application, the network device may be a device configured to communicate with a mobile device. The network device may be an access point (AP) in a WLAN, may be a base transceiver station (BTS) in GSM or CDMA, may be a NodeB (NB) in WCDMA, or may be an evolved NodeB (eNB or eNodeB) in LTE, or a relay station or an access point, or a vehicle-mounted device, a wearable device, a network device or gNB in an NR network, or a network device in a future evolved PLMN, or a network device in an NTN, or the like.

By way of example rather than limitation, in embodiments of this application, the network device may have a mobility characteristic. For example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, or a high elliptical orbit (HEO) satellite. Optionally, the network device may alternatively be a base station disposed in a location such as land or water.

In embodiments of this application, the network device may provide a service for a cell. The terminal device communicates with the network device by using a transmission resource (for example, a frequency domain resource or a spectrum resource) used by the cell. The cell may be a cell corresponding to the network device (for example, a base station). The cell may belong to a macro station or may belong to a base station corresponding to a small cell. The small cell herein may include a metro cell, a micro cell, a pico cell, a femto cell, or the like. These small cells have a characteristic of a small coverage range and low transmit power, and are applicable to providing a high-rate data transmission service.

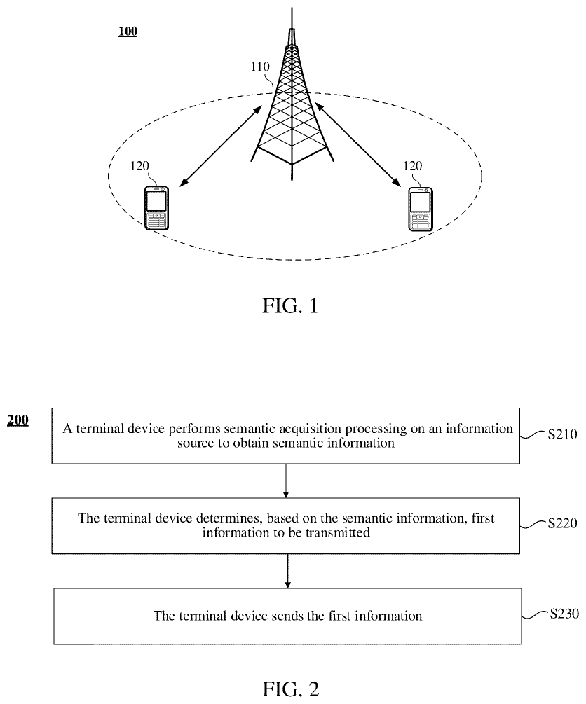

FIG. 1 exemplarily shows a communications system 100. The communications system 100 includes one network device 110 and two terminal devices 120. Optionally, the communications system 100 may include a plurality of network devices 110, and a coverage range of each network device 110 may include another quantity of terminal devices 120. This is not limited in embodiments of this application.

Optionally, the communications system 100 may further include another network entity such as a mobility management entity (MME) or an access and mobility management function (AMF). This is not limited in embodiments of this application.

The network device may further include an access network device and a core network device. That is, the wireless communications system further includes a plurality of core networks configured to communicate with the access network device. The access network device may be an evolved NodeB (evolutional node B, which may be an eNB or an e-NodeB for short), a macro base station, a micro base station (also referred to as a “small cell”), a pico base station, an access point (AP), a transmission point (TP), or a new generation NodeB (gNodeB), or the like in a long-term evolution (LTE) system, a next generation (mobile communications system) (next radio, NR) system, or an authorized auxiliary access long-term evolution (LAA-LTE) system.

It should be understood that in embodiments of this application, a device having a communication function in a network/system may be referred to as a communications device. The communications system shown in FIG. 1 is used as an example. The communications device may include a network device and a terminal device that have a communications function. The network device and the terminal device may be specific devices in embodiments of this application. Details are not described herein again. The communications device may further include another device in the communications system, for example, another network entity such as a network controller or a mobility management entity. This is not limited in embodiments of this application.

It should be understood that the terms “system” and “network” may often be used interchangeably herein. In this specification, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

It should be understood that, the “indication” mentioned in embodiments of this application may be a direct indication or an indirect indication, or indicate an association. For example, if A indicates B, it may mean that A directly indicates B, for example, B can be obtained from A. Alternatively, it may mean that A indicates B indirectly, for example, A indicates C, and B can be obtained from C. Alternatively, it may mean that there is an association between A and B.

In the description of embodiments of this application, the term “corresponding” may mean that there is a direct or indirect correspondence between two elements, or that there is an association between two elements, or that there is a relationship of “indicating” and “being indicated”, “configuring” and “being configured”, or the like.

To facilitate understanding of the technical solutions in embodiments of this application, the following describes related technologies in embodiments of this application. The following related technologies may be randomly combined with the technical solutions in embodiments of this application as optional solutions, which are all within the protection scope of embodiments of this application.

FIG. 2 is a schematic flowchart of a semantic communication transmission method 200 according to an embodiment of this application. Optionally, the method may be applied to the system shown in FIG. 1, but is not limited thereto. The method includes at least a part of the following content.

S210. A terminal device performs semantic acquisition processing on an information source to obtain semantic information.

In some examples, the terminal device may also be referred to as a transmit end (or an encoder). A semantic acquiring unit configured to implement the semantic acquisition processing may be added to the terminal device, so that the information source can be input into the semantic acquiring unit, and the semantic information is output and obtained after the semantic acquisition processing. The semantic acquiring unit may be implemented by using an artificial intelligence technology, for example, various neural networks obtained by using the artificial intelligence technology such as a convolutional neural network.

S220. The terminal device determines, based on the semantic information, first information to be transmitted.

In some examples, in addition to transmitting the semantic information, the semantic information and the information source may be transmitted (that is, on the side of the terminal device, in addition to “the information source” used as original information, “the semantic information” used as additional information may be included, and the first information to be transmitted is obtained accordingly).

S230. The terminal device sends the first information.

In some examples, as a transmit end, the terminal device may send, to a receive end, the first information as sending information to be transmitted, and the receive end may be a network device (for example, a base station), or may be a terminal device serving as a receive end, for example, a user who uses a mobile phone, a portable computer such as a tablet computer, or a desktop computer, to implement human-machine interaction communication transmission.

According to this embodiment of this application, a terminal device may perform semantic acquisition processing on an information source to obtain semantic information. The terminal device may determine, based on the semantic information, first information to be transmitted. As a transmit end, the terminal device sends the first information to a receive end, so that semantic communication transmission can be implemented, and constantly updated communication requirements can be met. That is, not only “the information source” used as original information can be transmitted, but also “the semantic information” used as additional information other than the original information can be transmitted.

In a possible implementation, that the terminal device determines, based on the semantic information, first information to be transmitted includes at least one of the following:

Manner 1: The terminal device obtains the first information through encoding and modulating the semantic information.

Manner 2: The terminal device obtains the first information through encoding, modulating, and encrypting the semantic information.

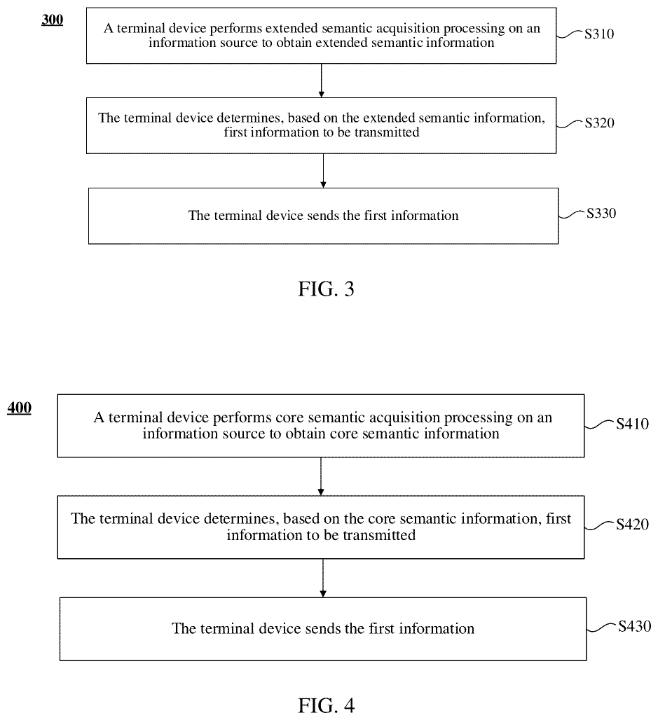

FIG. 3 is a schematic flowchart of a semantic communication transmission method 300 according to an embodiment of this application. Optionally, the method may be applied to the system shown in FIG. 1, but is not limited thereto. The method includes at least a part of the following content.

S310. A terminal device performs extended semantic acquisition processing on an information source to obtain extended semantic information.

In some examples, the terminal device may also be referred to as a transmit end (or an encoder). An extended semantic acquiring unit configured to implement the extended semantic acquisition processing may be added to the terminal device, so that the information source can be input into the extended semantic acquiring unit, and the extended semantic information is output and obtained after the extended semantic acquisition processing being performed. The extended semantic acquiring unit may be implemented by using an artificial intelligence technology, for example, various neural networks obtained by using the artificial intelligence technology such as a convolutional neural network.

In some examples, the extended semantic information includes at least one of emotion information, emphasis information, association information, prediction information, or different task priority information.

S320. The terminal device determines, based on the extended semantic information, first information to be transmitted.

In some examples, in addition to transmitting the extended semantic information, the extended semantic information and the information source may be transmitted (that is, on the side of the terminal device, in addition to “the information source” used as original information, “the extended semantic information” used as additional information may be included, and the first information to be transmitted is obtained accordingly). Comparing with “the information source” used as the original information, the extended semantic information aims at semantics that a transmit end (or an encoder) desires to send. Through extraction of the extended semantics, the extended semantic information is extracted from the original information, so that a case that a receive end (or a decoder) cannot acquire complete information can be avoided, thereby improving transmission accuracy and information integrity.

S330. The terminal device sends the first information.

In some examples, as a transmit end, the terminal device may send, to a receive end, the first information as sending information to be transmitted, and the receive end may be a network device (for example, a base station), or may be a terminal device serving as a receive end, for example, a user who uses a mobile phone, a portable computer such as a tablet computer, or a desktop computer, to implement human-machine interaction communication transmission.

In a possible implementation, that a terminal device performs extended semantic acquisition processing on an information source to obtain extended semantic information includes at least one of the following:

Manner 1: The information source is input into a first trained network model (the first network model may be deployed in the foregoing extended semantic acquiring unit), to obtain at least one of emotion information, emphasis information, association information, prediction information, or different task priority information, so as to obtain diversified extended semantic information.

Manner 2: The information source is input into a second trained network model (the second network model may be deployed in the foregoing extended semantic acquiring unit), to obtain at least one of different emotion information classifications, different emphasis information classifications, different association information supplements, different prediction information supplements, or different task priority information supplements, so as to obtain further information (for example, an information classification or an information supplement) of diversified extended semantic information.

In a possible implementation, the method further includes: performing classification processing on each piece of information in the extended semantic information based on different classifications, using corresponding identifier information as a classification identifier, and establishing a mapping relationship based on the classification identifier and a corresponding classification description. For example, classification processing is performed on the emotion information and the emphasis information, respectively, to establish a mapping relationship so as to obtain a mapping table. A mapping table for the emotion information includes an emotion classification described by using the classification identifier and a classification interpretation of the corresponding classification description. A mapping table for the emphasis information includes an importance classification described by using the classification identifier and a classification interpretation of the corresponding classification description.

FIG. 4 is a schematic flowchart of a semantic communication transmission method 400 according to an embodiment of this application. Optionally, the method may be applied to the system shown in FIG. 1, but is not limited thereto. The method includes at least a part of the following content.

S410. A terminal device performs core semantic acquisition processing on an information source to obtain core semantic information.

In some examples, the terminal device may also be referred to as a transmit end (or an encoder). A core semantic acquiring unit configured to implement the core semantic acquisition processing may be added to the terminal device, so that the information source can be input into the core semantic acquiring unit, and the core semantic information is output and obtained after the core semantic acquisition processing being performed. The core semantic acquiring unit may be implemented by using an artificial intelligence technology, for example, various neural networks obtained by using the artificial intelligence technology such as a convolutional neural network.

S420. The terminal device determines, based on the core semantic information, first information to be transmitted.

In some examples, in addition to transmitting the core semantic information, the core semantic information and the information source may be transmitted (that is, on the side of the terminal device, in addition to “the information source” used as original information, “the core semantic information” used as additional information may be included, and the first information to be transmitted is obtained accordingly). Comparing with “the information source” used as the original information, the core semantic information aims at semantics that a receive end (or a decoder) desires to receive. Through extraction of the core semantics, the core semantic information is extracted from the original information, so that transmission of unnecessary information for the receive end (or the decoder) can be avoided, and only the core semantic information is transmitted, thereby improving transmission efficiency.

S430. The terminal device sends the first information.

In some examples, as a transmit end, the terminal device may send, to a receive end, the first information as sending information to be transmitted, and the receive end may be a network device (for example, a base station), or may be a terminal device serving as a receive end, for example, a user who uses a mobile phone, a portable computer such as a tablet computer, or a desktop computer, to implement human-machine interaction communication transmission.

In a possible implementation, that a terminal device performs core semantic acquisition processing on an information source to obtain core semantic information includes: inputting the information source into a third trained network model (the third network model may be deployed in the foregoing core semantic acquiring unit) to obtain the core semantic information. The core semantic information is used to describe an operant behavior of a user (or referred to as a non-modifying/non-descriptive behavior of the user), for example, a behavior, an action, an instruction, data, or a command, so as to obtain diversified core semantic information.

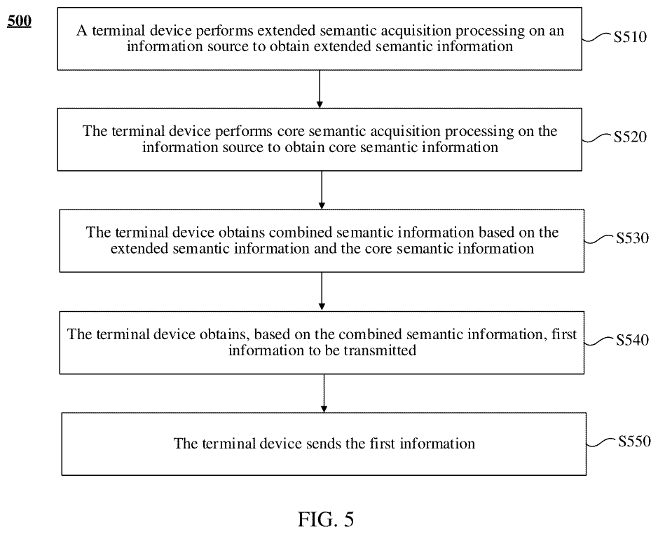

FIG. 5 is a schematic flowchart of a semantic communication transmission method 500 according to an embodiment of this application. Optionally, the method may be applied to the system shown in FIG. 1, but is not limited thereto. The method includes at least a part of the following content.

S510. A terminal device performs extended semantic acquisition processing on an information source to obtain extended semantic information.

S520. The terminal device performs core semantic acquisition processing on the information source to obtain core semantic information.

S530. The terminal device obtains combined semantic information based on the extended semantic information and the core semantic information.

In some examples, the terminal device may also be referred to as a transmit end (or an encoder). A combined semantic acquiring unit configured to implement the extended semantic and core semantic acquisition processing (that is, the combined semantic acquiring unit can implement both the extended semantic acquisition processing and the core semantic acquisition processing) may be added to the terminal device, so that the information source can be input into the combined semantic acquiring unit, and the extended semantic information and the core semantic information are output and obtained after the extended semantic and core semantic acquisition processing being performed (the extended semantic information and the core semantic information constitute the combined semantic information). The combined semantic acquiring unit may be implemented by using an artificial intelligence technology, for example, various neural networks obtained by using the artificial intelligence technology such as a convolutional neural network.

S540. The terminal device determines, based on the combined semantic information, first information to be transmitted.

In some examples, in addition to transmitting the extended semantic information and the core semantic information in the combined semantic information, the extended semantic information, the core semantic information, and the information source may be transmitted (that is, on the side of the terminal device, in addition to “the information source” used as original information, “the extended semantic information and the core semantic information” used as additional information may be included, and the first information to be transmitted is obtained accordingly). Comparing with “the information source” used as original information, the extended semantic information aims at semantics that a transmit end (or an encoder) desires to send. Through extraction of the extended semantics, the extended semantic information is extracted from the original information, so that a case that a receive end (or a decoding) cannot acquire complete information can be avoided, thereby improving transmission accuracy and information integrity. Comparing with “the information source” used as original information, the core semantics is core semantics extracted from the original information with an aim to semantics that a receive end (or a decoder) desires to receive. Through extraction of the core semantics, transmission of unnecessary information for the receive end (or the decoder) can be avoided, thereby improving transmission efficiency.

S550. The terminal device sends the first information.

In some examples, as a transmit end, the terminal device may send, to a receive end, the first information as sending information to be transmitted, and the receive end may be a network device (for example, a base station), or may be a terminal device serving as a receive end, for example, a user who uses a mobile phone, a portable computer such as a tablet computer, or a desktop computer, to implement human-machine interaction communication transmission.

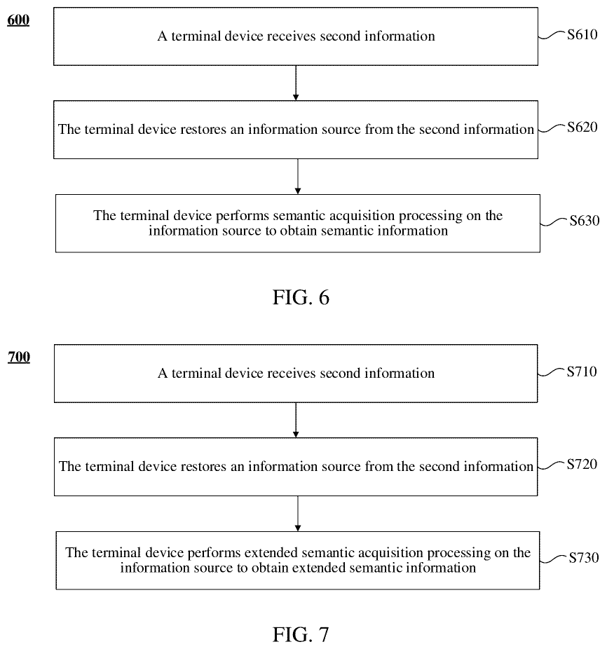

FIG. 6 is a schematic flowchart of a semantic communication transmission method 600 according to an embodiment of this application. Optionally, the method may be applied to the system shown in FIG. 1, but is not limited thereto. The method includes at least a part of the following content.

S610. A terminal device receives second information.

In some examples, in addition to the terminal device used as a receive end (for example, a user who uses a mobile phone, a portable computer such as a tablet computer, or a desktop computer, to implement human-machine interaction communication transmission), the receive end may be a network device (for example, a base station). The second information may also be the first information in the foregoing embodiment. There are two scenarios. In a first scenario, both a transmit end and a receive end have a semantic acquiring unit. The first information includes an information source and carried semantic information, and the receive end directly restores the information source and the semantic information. In a second scenario, a semantic acquiring unit may not be disposed in a transmit end, and only a receive end has a semantic acquiring unit. After restoring an information source, the receive end performs semantic acquisition on the information source to obtain semantic information.

Specifically, the second information and the first information in the foregoing embodiment may be same information (for example, both the first information and the second information include only the semantic information; or the first information and the second information include not only the semantic information but also the information source and the like). Alternatively, the second information and the first information in the foregoing embodiment may be different information (for example, the first information includes not only the semantic information but also the information source, but the second information includes only the information source). In other words, in an example in which the receive end is a network device, that each of the terminal device and the network device may perform semantic acquisition processing on the information source to obtain the semantic information includes but is not limited to: the terminal device and the network device are used together to complete encoding and decoding processing, or the terminal device and the network device may perform encoding and decoding processing with respect to the semantic acquisition processing, respectively.

S620. The terminal device restores an information source from the second information.

In some examples, that the terminal device restores an information source from the second information may include at least one of the following:

Manner 1: The terminal device obtains the information source through decoding and demodulating the second information.

Manner 2: The terminal device obtains the information source through decoding, demodulating, and decrypting the second information.

S630. The terminal device performs semantic acquisition processing on the information source to obtain semantic information.

In some examples, the terminal device may also be referred to as a receive end (or a decoder). A semantic acquiring unit configured to implement the semantic acquisition processing may be added to the terminal device, so that the information source can be input into the semantic acquiring unit, and the semantic information is output and obtained after the semantic acquisition processing being performed. The semantic acquiring unit may be implemented by using an artificial intelligence technology, for example, various neural networks obtained by using the artificial intelligence technology such as a convolutional neural network.

According to this embodiment of this application, after restoring an information source from second information, a terminal device may perform semantic acquisition processing on the information source to obtain semantic information, thereby implementing semantic communication transmission.

FIG. 7 is a schematic flowchart of a semantic communication transmission method 700 according to an embodiment of this application. Optionally, the method may be applied to the system shown in FIG. 1, but is not limited thereto. The method includes at least a part of the following content.

S710. A terminal device receives second information.

In some examples, in addition to the terminal device used as a receive end (for example, a user who uses a mobile phone, a portable computer such as a tablet computer, or a desktop computer, to implement human-machine interaction communication transmission), the receive end may be a network device (for example, a base station). The second information may also be the first information in the foregoing embodiment. There are two scenarios. In a first scenario, both a transmit end and a receive end have a semantic acquiring unit. The first information includes an information source and carried semantic information, and the receive end directly restores the information source and the semantic information. In a second scenario, a semantic acquiring unit may not be disposed in a transmit end, and only a receive end has a semantic acquiring unit. After restoring an information source, the receive end performs semantic acquisition on the information source to obtain semantic information.

Specifically, the second information and the first information in the foregoing embodiment may be same information (for example, both the first information and the second information include only the semantic information; or the first information and the second information include not only the semantic information but also the information source and the like). Alternatively, the second information and the first information in the foregoing embodiment may be different information (for example, the first information includes not only the semantic information but also the information source, but the second information includes only the information source). In other words, in an example in which the receive end is a network device, that each of the terminal device and the network device may perform semantic acquisition processing on the information source to obtain the semantic information includes but is not limited to: the terminal device and the network device are used together to complete encoding and decoding processing, or the terminal device and the network device may perform encoding and decoding processing with respect to the semantic acquisition processing, respectively.

S720. The terminal device restores an information source from the second information.

In some examples, that the terminal device restores an information source from the second information may include at least one of the following:

Manner 1: The terminal device obtains the information source through decoding and demodulating the second information.

Manner 2: The terminal device obtains the information source through decoding, demodulating, and decrypting the second information.

S730. The terminal device performs extended semantic acquisition processing on the information source to obtain extended semantic information.

In some examples, the terminal device may also be referred to as a receive end (or a decoder). An extended semantic acquiring unit configured to implement the extended semantic acquisition processing may be added to the terminal device, so that the information source can be input into the extended semantic acquiring unit, and the extended semantic information is output and obtained after the extended semantic acquisition processing being performed. The extended semantic acquiring unit may be implemented by using an artificial intelligence technology, for example, various neural networks obtained by using the artificial intelligence technology such as a convolutional neural network.

In some examples, the extended semantic information includes at least one of emotion information, emphasis information, association information, prediction information, or different task priority information.

In a possible implementation, that the terminal device performs extended semantic acquisition processing on the information source to obtain extended semantic information includes at least one of the following:

Manner 1: The information source is input into a fourth trained network model (the fourth network model may be deployed in the foregoing extended semantic acquiring unit), to obtain at least one of emotion information, emphasis information, association information, prediction information, or different task priority information, so as to obtain diversified extended semantic information.

Manner 2: The information source is input into a fifth trained network model (the fifth network model may be deployed in the foregoing extended semantic acquiring unit), to obtain at least one of different emotion information classifications, different emphasis information classifications, different association information supplements, different prediction information supplements, or different task priority information supplements, so as to obtain further information (for example, an information classification or an information supplement) of diversified extended semantic information.

In a possible implementation, the method further includes: performing classification processing on each piece of information in the extended semantic information based on different classifications, using corresponding identifier information as a classification identifier, and establishing a mapping relationship based on the classification identifier and a corresponding classification description. For example, classification processing is performed on the emotion information and the emphasis information, respectively, to establish a mapping relationship so as to obtain a mapping table. A mapping table for the emotion information includes an emotion classification described by using the classification identifier and a classification interpretation of the corresponding classification description. A mapping table for the emphasis information includes an importance classification described by using the classification identifier and a classification interpretation of the corresponding classification description.

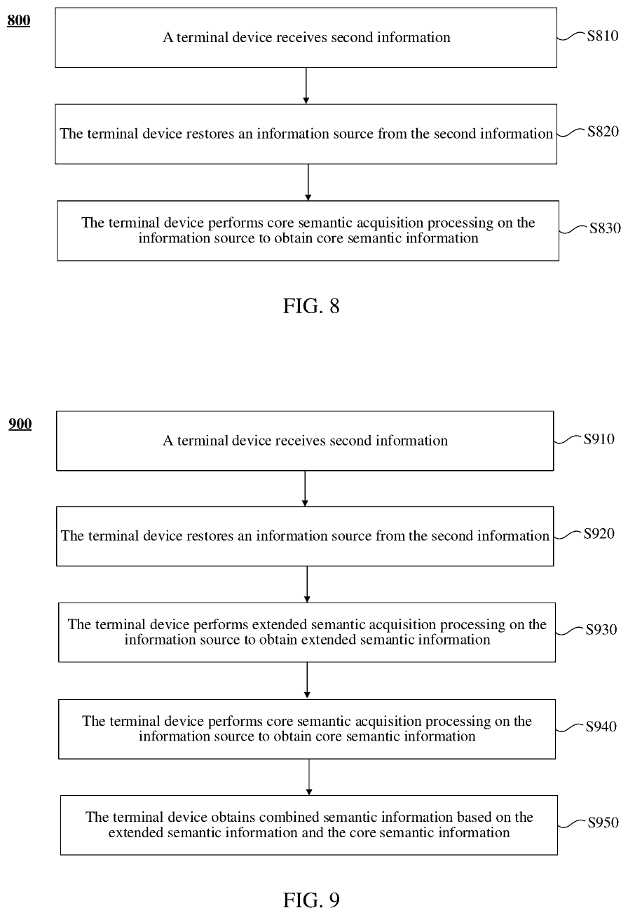

FIG. 8 is a schematic flowchart of a semantic communication transmission method 800 according to an embodiment of this application. Optionally, the method may be applied to the system shown in FIG. 1, but is not limited thereto. The method includes at least a part of the following content.

S810. A terminal device receives second information.

In some examples, in addition to the terminal device used as a receive end (for example, a user who uses a mobile phone, a portable computer such as a tablet computer, or a desktop computer, to implement human-machine interaction communication transmission), the receive end may be a network device (for example, a base station). The second information may also be the first information in the foregoing embodiment. There are two scenarios. In a first scenario, both a transmit end and a receive end have a semantic acquiring unit. The first information includes an information source and carried semantic information, and the receive end directly restores the information source and the semantic information. In a second scenario, a semantic acquiring unit may not be disposed in a transmit end, and only a receive end has a semantic acquiring unit. After restoring an information source, the receive end performs semantic acquisition on the information source to obtain semantic information.

Specifically, the second information and the first information in the foregoing embodiment may be same information (for example, both the first information and the second information include only the semantic information; or the first information and the second information include not only the semantic information but also the information source and the like). Alternatively, the second information and the first information in the foregoing embodiment may be different information (for example, the first information includes not only the semantic information but also the information source, but the second information includes only the information source). In other words, in an example in which the receive end is a network device, that each of the terminal device and the network device may perform semantic acquisition processing on the information source to obtain the semantic information includes but is not limited to: the terminal device and the network device are used together to complete encoding and decoding processing, or the terminal device and the network device may perform encoding and decoding processing with respect to the semantic acquisition processing, respectively.

S820. The terminal device restores an information source from the second information.

In some examples, that the terminal device restores an information source from the second information may include at least one of the following:

Manner 1: The terminal device obtains the information source through decoding and demodulating the second information.

Manner 2: The terminal device obtains the information source through decoding, demodulating, and decrypting the second information.

S830. The terminal device performs core semantic acquisition processing on the information source to obtain core semantic information.

In some examples, the terminal device may also be referred to as a receive end (or a decoder). A core semantic acquiring unit configured to implement the core semantic acquisition processing may be added to the terminal device, so that the information source can be input into the core semantic acquiring unit, and the core semantic information is output and obtained after the core semantic acquisition processing being performed. The core semantic acquiring unit may be implemented by using an artificial intelligence technology, for example, various neural networks obtained by using the artificial intelligence technology such as a convolutional neural network.

In some examples, the core semantic information is used to describe an operant behavior of a user (or referred to as a non-modifying/non-descriptive behavior of the user), for example, a behavior, an action, an instruction, data, or a command, so as to obtain diversified core semantic information.

In a possible implementation, that terminal device performs core semantic acquisition processing on the information source to obtain core semantic information includes:
inputting the information source into a sixth trained network model (the sixth network model may be deployed in the foregoing core semantic acquiring unit) to obtain the core semantic information.

FIG. 9 is a schematic flowchart of a semantic communication transmission method 900 according to an embodiment of this application. Optionally, the method may be applied to the system shown in FIG. 1, but is not limited thereto. The method includes at least a part of the following content.

S910. A terminal device receives second information.

In some examples, in addition to the terminal device used as a receive end (for example, a user who uses a mobile phone, a portable computer such as a tablet computer, or a desktop computer, to implement human-machine interaction communication transmission), the receive end may be a network device (for example, a base station). The second information may also be the first information in the foregoing embodiment. There are two scenarios. In a first scenario, both a transmit end and a receive end have a semantic acquiring unit. The first information includes an information source and carried semantic information, and the receive end directly restores the information source and the semantic information. In a second scenario, a semantic acquiring unit may not be disposed in a transmit end, and only a receive end has a semantic acquiring unit. After restoring an information source, the receive end performs semantic acquisition on the information source to obtain semantic information.

Specifically, the second information and the first information in the foregoing embodiment may be same information (for example, both the first information and the second information include only the semantic information; or the first information and the second information include not only the semantic information but also the information source and the like). Alternatively, the second information and the first information in the foregoing embodiment may be different information (for example, the first information includes not only the semantic information but also the information source, but the second information includes only the information source). In other words, in an example in which the receive end is a network device, that each of the terminal device and the network device may perform semantic acquisition processing on the information source to obtain the semantic information includes but is not limited to: the terminal device and the network device are used together to complete encoding and decoding processing, or the terminal device and the network device may perform encoding and decoding processing with respect to the semantic acquisition processing, respectively.

S920. The terminal device restores an information source from the second information.

In some examples, that the terminal device restores an information source from the second information may include at least one of the following:

Manner 1: The terminal device obtains the information source through decoding and demodulating the second information.

Manner 2: The terminal device obtains the information source through decoding, demodulating, and decrypting the second information.

S930. The terminal device performs extended semantic acquisition processing on the information source to obtain extended semantic information.

S940. The terminal device performs core semantic acquisition processing on the information source to obtain core semantic information.

S950. The terminal device obtains combined semantic information based on the extended semantic information and the core semantic information.

In some examples, the terminal device may also be referred to as a receive end (or a decoder). A combined semantic acquiring unit configured to implement the extended semantic and core semantic acquisition processing (that is, the combined semantic acquiring unit can implement both the extended semantic acquisition processing and the core semantic acquisition processing) may be added to the terminal device, so that the information source can be input into the combined semantic acquiring unit, and the extended semantic information and the core semantic information are output and obtained after the extended semantic and core semantic acquisition processing being performed (the extended semantic information and the core semantic information constitute the combined semantic information). The combined semantic acquiring unit may be implemented by using an artificial intelligence technology, for example, various neural networks obtained by using the artificial intelligence technology such as a convolutional neural network.

In some examples, the extended semantic information includes at least one of emotion information, emphasis information, association information, prediction information, or different task priority information.

In some examples, the core semantic information is used to describe an operant behavior of a user (or referred to as a non-modifying/non-descriptive behavior of the user), for example, a behavior, an action, an instruction, data, or a command, so as to obtain diversified core semantic information.

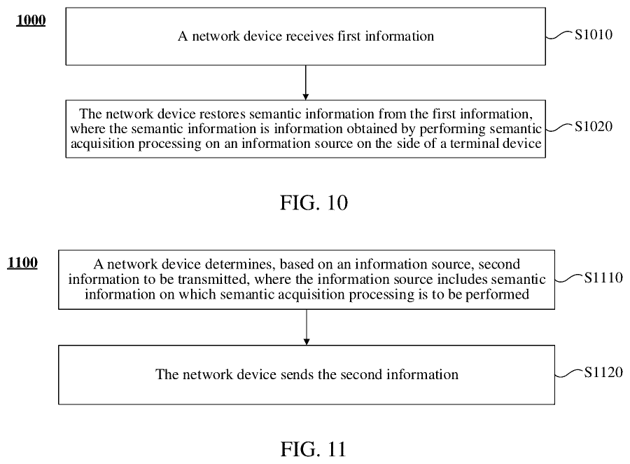

FIG. 10 is a schematic flowchart of a semantic communication transmission method according to an embodiment of this application. Optionally, the method may be applied to the system shown in FIG. 1, but is not limited thereto. The method includes at least a part of the following content.

S1010. A network device receives first information.

S1020. The network device restores semantic information from the first information, where the semantic information is information obtained by performing semantic acquisition processing on an information source on the side of a terminal device.

In some examples, the network device obtains the semantic information through decoding and demodulating the first information; or the network device obtains the semantic information through decoding, demodulating, and decrypting the first information.

In some examples, the semantic information includes at least one of extended semantic information or core semantic information.

In some examples, the extended semantic information includes at least one of emotion information, emphasis information, association information, prediction information, or task priority information.

In some examples, the extended semantic information also includes at least one of an emotion information classification, an emphasis information classification, an association information supplement, a prediction information supplement, or a task priority information supplement.

In some examples, the core semantic information includes at least one of a behavior, an action, an instruction, data, or a command.

According to this embodiment of this application, semantic information acquisition processing is performed on the side of a terminal device, that is, the terminal device may perform semantic acquisition processing on an information source to obtain semantic information. After obtaining, based on the semantic information, first information to be transmitted, the terminal device serving as a transmit end sends the first information to a receive end. In a case of being a network device, the receive end receives the first information, and restores the semantic information from the first information, so that semantic communication transmission can be implemented between the terminal device and the network device, and continuously updated communication requirements can be met. That is, not only “the information source” used as original information can be transmitted, but also “the semantic information” used as additional information other than the original information can be transmitted.

FIG. 11 is a schematic flowchart of a semantic communication transmission method according to an embodiment of this application. Optionally, the method may be applied to the system shown in FIG. 1, but is not limited thereto. The method includes at least a part of the following content.

S1110. A network device determines, based on an information source, second information to be transmitted, where the information source includes semantic information on which semantic acquisition processing is to be performed.

In some examples, the network device determines the second information through encoding and modulating the information source; or the network device determines the second information through encoding, modulating, and encrypting the information source.

S1120. The network device sends the second information.

In some examples, the semantic information includes at least one of extended semantic information or core semantic information.

In some examples, the extended semantic information includes at least one of emotion information, emphasis information, association information, prediction information, or task priority information.

In some examples, the extended semantic information includes at least one of an emotion information classification, an emphasis information classification, an association information supplement, a prediction information supplement, or a task priority information supplement.

In some examples, the core semantic information includes at least one of a behavior, an action, an instruction, data, or a command.

According to this embodiment of this application, as a transmit end, a network device may determine, based on an information source, second information to be transmitted, where the information source includes semantic information on which semantic acquisition processing is to be performed; and sends the second information to a terminal device. On the side of the terminal device, semantic information acquisition processing is performed. That is, after restoring the information source from the received second information, the terminal device serving as a receive end may perform semantic acquisition processing on the information source to obtain the semantic information, so that semantic communication transmission can be implemented between the terminal device and the network device, and continuously updated communication requirements can be met. That is, not only “the information source” used as original information can be transmitted, but also “the semantic information” used as additional information other than the original information can be transmitted.

The following describes in detail the semantic communication transmission method provided in the foregoing embodiments of this application.

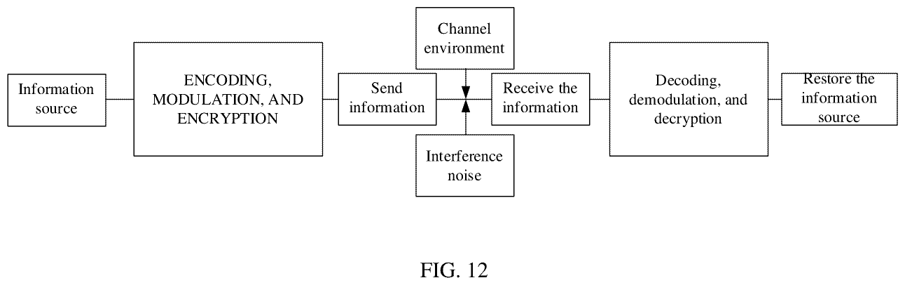

FIG. 12 is a schematic diagram of schematic coding and decoding in an example of a semantic communication transmission method according to an embodiment of this application. As shown in FIG. 12, a basic working procedure in a wireless communications system includes: A transmitter performs operations such as encoding, modulation, and encryption on an information source at a transmit end to form sending information to be transmitted. The sending information is transmitted to a receive end by using wireless space. The receive end performs operations such as decoding, decryption, and demodulation on the received information, and finally restores the information source, to implement lossless transmission of “the information source” used as original information.

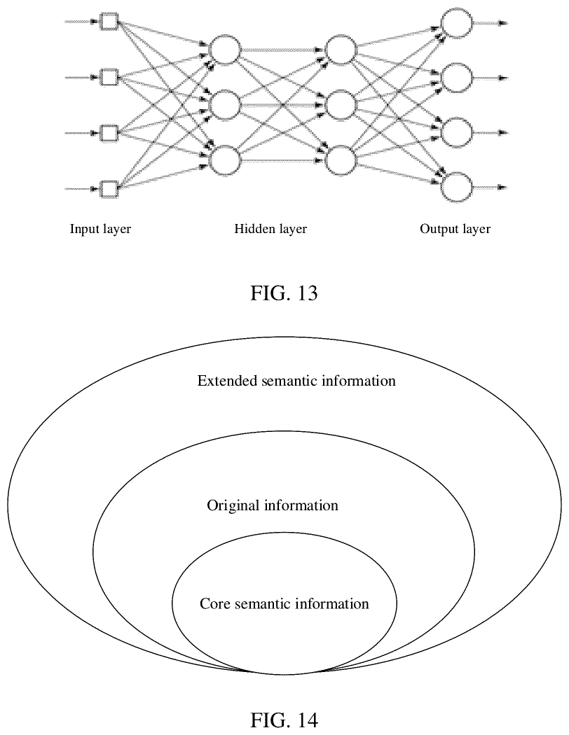

FIG. 13 is a schematic diagram of a schematic neural network in an example of a semantic communication transmission method according to an embodiment of this application. As shown in FIG. 13, a basic structure of the neural network includes an input layer, a hidden layer, and an output layer. After receiving data by the input layer, the received data is processed by the hidden layer, and a final data processing result is generated at the output layer. Each node in the neural network represents one processing unit, and may be considered as being simulating a neuron. A plurality of neurons form a layer of neural network, and multi-layer information transfer and processing constitute a whole neural network.

FIG. 14 is a schematic diagram of a schematic inter-information relationship in an example of a semantic communication transmission method according to an embodiment of this application. As shown in FIG. 14, core semantic information, original information, and extended semantic information are included. The original information may be the foregoing information source, and may be transmitted based on the wireless communications system architecture shown in FIG. 12. Compared with the information source, the core semantic information and the extended semantic information are additional information that needs to be transmitted after the wireless communications system architecture is improved. In other words, a design objective of the current wireless communications system is lossless transmission of the original information from a transmit end to a receive end. However, in at least the following two cases (a first-type scenario and a second-type scenario), lossless transmission of only original information is not all requirements for communication transmission. In addition to the lossless transmission of the original information, the wireless communications system architecture needs to be updated to meet a lossless transmission requirement of more information (for example, semantic information such as core semantic information and extended semantic information).

The neural network shown in FIG. 13 is only a basic architecture. With continuous development of neural network research, more neural network deep learning algorithms and a relatively large quantity of hidden layers may be introduced, so that feature learning may be performed by using the multi-hidden-layer neural network through layer-by-layer training, thereby greatly improving a learning and processing capability of the neural network. The neural network is deployed in software/hardware for various application scenarios (scenarios such as natural language processing, semantic analysis and understanding, mode recognition, signal processing, optimization combination, and abnormal detection), so that a processing speed and precision of the software/hardware can be improved. The neural network may be applied to at least the following two cases, to implement a lossless transmission requirement of semantic information such as core semantic information and extended semantic information.

First-type scenario: Acquire extended semantic information from original information and transmit the extended semantic information.

Taking human-to-human direct communication as an example, context information, a communication environment, an expressed emotion, and an emphasis of same exchange content may vary with different presentation environments and manners. As such, even though identical original information is transmitted, different expression effects, different emphasis effects, and different perceptual effects may be brought about. In such a case, simple transmission of the original information cannot carry complete exchange information. Even if the receive end completely receives the original information without any loss, the receive end cannot accurately recognize additional information carried by specific context information, an exchange environment, an expressed emotion, and emphasis. A cognitive difference between the receive end as a machine and a human being lies in that if both parties in interaction are human beings, since the human beings have certain emotion understanding capabilities as compared with machines, this problem may be relatively weakened, even if the human beings have different degrees of emotion understanding capabilities. This is similar to the following case in a physical world: face-to-face communication, voice communication and text communication between human beings bring different exchange effects for same exchange content. However, due to the lack of an emotion understanding capability for machines, a technical means is required to make up for an issue due to the lack of the emotion understanding capability. Therefore, in machine-machine interaction, in addition to lossless transmission of original information, a architecture for wireless communication systems needs to be updated to meet a lossless transmission requirement for more information. For the first-type scenario, acquisition and information transfer of additional information are performed in addition to transmission of the original information, and this type of additional information is collectively referred to as extended semantic information. In human-human interaction, human-machine interaction, machine-machine interaction, especially in scenarios of human-machine interaction and machine-machine interaction, when at least one party in the interaction is lack or weak in a capability of actively acquiring and understanding the extended semantics, or when the capability is not symmetric, how to optimize the design of the communications system to complete acquisition and transfer of additional information (for example, extended semantic information) other than original information is a problem that needs to be resolved.

Second-type scenario: Extract core semantic information from original information and transmit the core semantic information.

Original information generally includes core information to be expressed and non-core information used to modify the core information. For example, when A expresses a large amount of information describing a book while hoping that B can lend the book to A, hoping to borrow the book is core information to be expressed, but the description about the book is not core information of this part of content. There are a large quantity of such descriptions in human-to-human interaction. If an intention for carrying out communication transmission is to transmit only core information in original information, only the core information may be transmitted. For the second-type scenario, acquisition and information transfer of additional information are performed in addition to transmission of the original information, and this type of additional information is collectively referred to as core semantic information. In human-human interaction, human-machine interaction, machine-machine interaction, especially in a human-to-machine interaction scenario, when at least one party in the interaction adds non-core semantics to information to be exchanged, and the other party in the interaction does not need the non-core semantics, how to optimize the design of the communications system to complete acquisition and transfer of additional information (for example, core semantic information) other than original information is a problem that needs to be resolved.

In conclusion, for the first-type scenario, the additional extended semantic information needs to be obtained based on the original information. For the second-type scenario, the extracted core semantic information needs to be obtained based on the original information. Related encoding, decoding, and transmission of the extended semantic information and the core semantic information in the foregoing process, and an update design of the entire system are described as below.

I. Semantic communication transmission on a transmit end (or referred to as an encoder): In an encoder-oriented semantic communications system, there are three cases: extended semantic communication, core semantic communication, and extended semantic and core semantic joint communication.

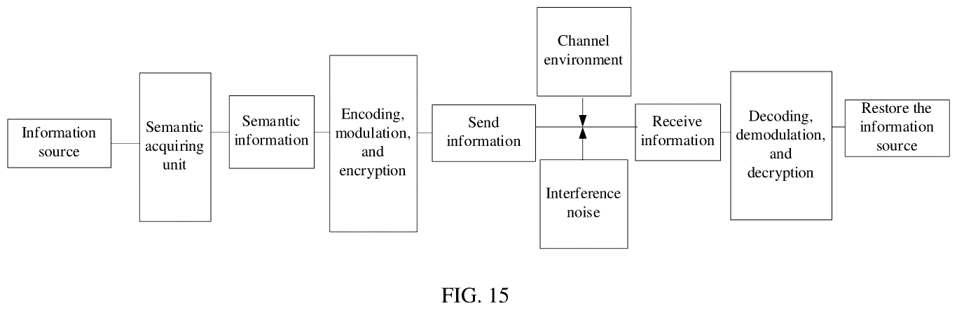

FIG. 15 is a schematic diagram of schematic coding and decoding in an example of a semantic communication transmission method according to an embodiment of this application. As shown in FIG. 15, in comparison with the working procedure shown in FIG. 12, in a working procedure of a wireless communications system in which an encoder is mainly used to implement semantic communication transmission, an additional semantic acquiring unit is required to be added. According to the three cases of extended semantic communication, core semantic communication, and extended semantic and core semantic joint communication, an extended semantic acquiring unit (configured to acquire extended semantic information), a core semantic acquiring unit (configured to acquire core semantic information), and a combined semantic acquiring unit (configured to acquire extended semantic and core semantic information) may be specifically required, thereby implementing a function of acquiring semantic information from original information (an information source).

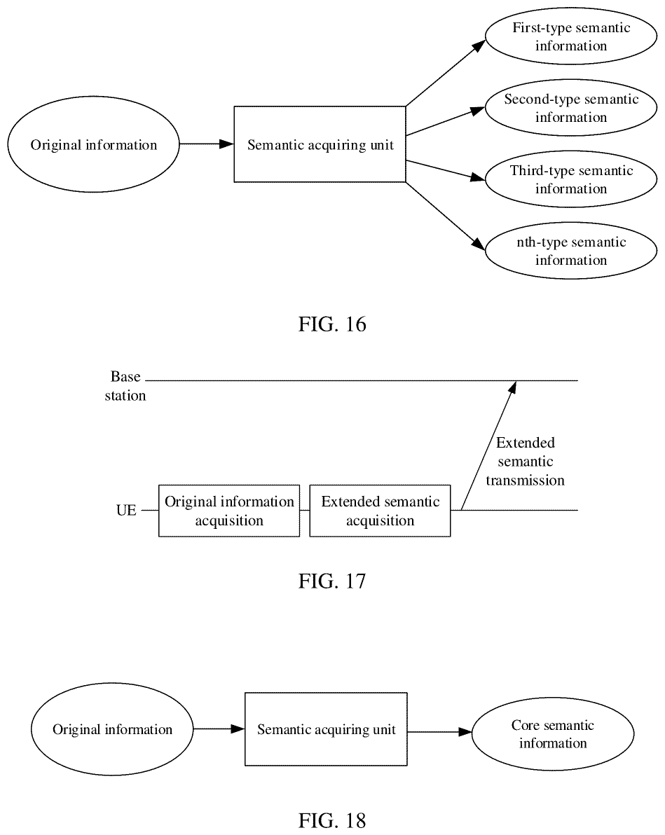

FIG. 16 is a schematic diagram of schematic extended semantic acquisition in an example of a semantic communication transmission method according to an embodiment of this application. As shown in FIG. 16, when a semantic acquiring unit is configured to acquire extended semantic information, the semantic acquiring unit may be an extended semantic acquiring unit. Output information of the extended semantic acquiring unit includes extended semantic information expressed by original information, and the extended semantic information includes a plurality of types of semantic information, for example, one or more of extended semantic information such as emotion information, emphasis information, association information, prediction information, or different task priority information.

For emotion information, there may be classifications of the emotion information in advance, and different emotion classifications correspond to different identifiers. As shown in Table 1, the extended semantic information may be represented and transmitted for classification identifier information of different emotions.

TABLE 1

| Emotion classification | Classification description |
|---|---|
| 1 | Emotion 1, for example, joy |
| 2 | Emotion 2, for example, anger |
| 3 | Emotion 3, for example, sorrow |
| 4 | Emotion 4, for example, happiness |

For emphasis information or key information to be emphasized, original information may be classified, and different classifications correspond to different importance identifiers or weights, or local original information that needs to be emphasized is directly output, for example, as shown in Table 2 and Table 3.

TABLE 2

| Importance classification | Classification description |
|---|---|
| 1 | Emphasis part 1, for example, |
| | emphasizing a subject |
| 2 | Emphasis part 2, for example, |
| | emphasizing a predicate |
| 3 | Emphasis part 3, for example, |
| | emphasizing an object |
| 4 | Emphasis part 4, for example, |
| | emphasizing a verb |
| 5 | Emphasis part 5, for example, |
| | emphasizing a noun |
| 6 | Emphasis part 6, for example, |
| | emphasizing a modifier |

TABLE 3

| Importance classification | Classification description |
|---|---|
| 1 | Emphasis part 1, for example, |
| | emphasizing a person |
| 2 | Emphasis part 2, for example, |
| | emphasizing a vehicle |
| 3 | Emphasis part 3, for example, |
| | emphasizing an environment. |
| 4 | Emphasis part 4, for example, |
| | emphasizing a location |
| 5 | Emphasis part 5, for example, |
| | emphasizing a text |
| 6 | Emphasis part 6, for example, |
| | emphasizing voice |
| 7 | Emphasis part 7, for example, |
| | emphasizing a picture |

FIG. 17 is a schematic diagram of schematic extended semantic transmission in an example of a semantic communication transmission method according to an embodiment of this application. As shown in FIG. 17, after performing semantic information acquisition processing on original information to obtain extended semantic information on the side of UE, the extended semantic information is transmitted to a base station. As compared with the original information, the extended semantic information is obtained from the original information with an aim to semantics that a transmit end desires to send. Through extraction of this part of extended semantics, a case that a receive end cannot obtain complete information that the transmit end desires to transfer can be avoided, thereby improving transmission accuracy.

The foregoing semantic acquiring unit may be implemented by using a neural network. For example, an input of the neural network is original information, and an output thereof is one or more of extended semantic information such as different emotion information or classifications, different emphasis content information or classifications, different association information supplements, different prediction information supplements, or different task priority supplements. A structure of the neural network may be one or more of a fully-connected structure, a convolutional structure, a recurrent neural network (RNN) structure, a long-short term memory network (LSTM) structure, a self-attention mechanism (self-attention) structure, a transformer structure consisting of a self-attention network and a feedforward neural network.

FIG. 18 is a schematic diagram of schematic core semantic acquisition in an example of a semantic communication transmission method according to an embodiment of this application. As shown in FIG. 18, when a semantic acquiring unit is configured to acquire core semantic information, the semantic acquiring unit may be a core semantic acquiring unit. Output information of the core semantic acquiring unit includes core semantic information expressed by original information. As compared with the original information, the core semantic information is obtained from the original information with an aim to semantics that a receive end desires to receive. Through extraction of this part of core semantics, transmission of unnecessary information for the receive end can be avoided, thereby improving transmission efficiency.

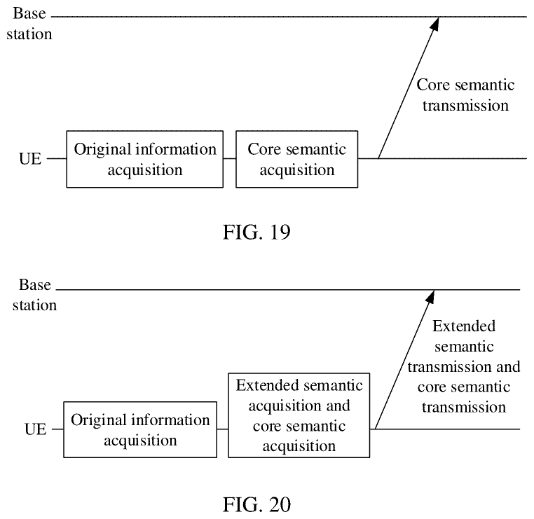

FIG. 19 is a schematic diagram of schematic core semantic transmission in an example of a semantic communication transmission method according to an embodiment of this application. As shown in FIG. 19, after performing semantic information acquisition processing on original information on the side of UE to obtain core semantic information, the core semantic information is transmitted to a base station. The foregoing semantic acquiring unit may be implemented by using a neural network. For example, an input of the neural network is original information, and an output thereof is core semantic information. A structure of the neural network may be one or more of a fully-connected structure, a convolutional structure, an RNN structure, an LSTM structure, a self-attention structure, or a transformer structure consisting of a self-attention network and a feedforward neural network.

FIG. 20 is a schematic diagram of schematic combined semantic transmission in an example of a semantic communication transmission method according to an embodiment of this application. As shown in FIG. 20, a semantic acquiring unit may also be configured to acquire extended semantics and core semantics, and may be implemented through a union of the implementation manners for the foregoing two cases. After performing extended semantic and core information acquisition processing on original information on the side of UE to obtain extended semantic and core semantic information, the extended semantic and core semantic information are transmitted to a base station jointly. Details are not described herein again.

II. Semantic communication transmission on a receive end (or referred to as a decoder): In a decoder-oriented semantic communications system, there are three cases: extended semantic communication, core semantic communication, and extended semantic and core semantic joint communication.

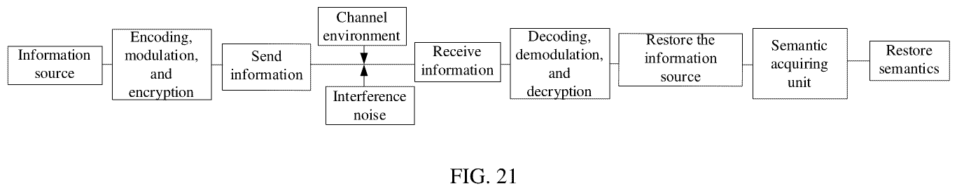

FIG. 21 is a schematic diagram of schematic coding and decoding in an example of a semantic communication transmission method according to an embodiment of this application. As shown in FIG. 21, in comparison with the working procedure shown in FIG. 12, in a working procedure of a wireless communications system in which a decoder is mainly used to implement semantic communication transmission, an additional semantic acquiring unit is required to be added. According to the three cases of extended semantic communication, core semantic communication, and extended semantic and core semantic joint communication, an extended semantic acquiring unit (configured to acquire extended semantic information), a core semantic acquiring unit (configured to acquire core semantic information), and a combined semantic acquiring unit (configured to acquire extended semantic and core semantic information) may be specifically required, thereby implementing a function of acquiring semantic information from original information (an information source).

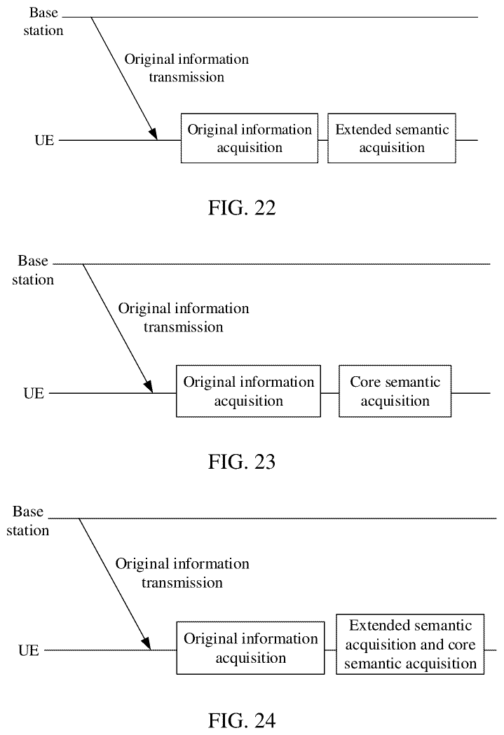

FIG. 22 to FIG. 24 are schematic diagrams of schematic extended semantic transmission, core semantic transmission, and extended semantic and core semantic joint transmission in an example of a semantic communication transmission method according to an embodiment of this application, respectively. As shown in FIG. 22, UE receives original information from a base station, and performs semantic information acquisition processing on the original information from the UE side to obtain extended semantic information. As shown in FIG. 23, UE receives original information from a base station, and performs core information acquisition processing on the original information from the UE side to obtain core semantic information. As shown in FIG. 24, UE receives original information from a base station, and performs extended semantic and core information acquisition processing on the original information from the UE side to obtain extended semantic and core semantic information.

The foregoing semantic acquiring unit may be implemented by using a neural network. For example, an input of the neural network is original information, and an output thereof is core semantic information. A structure of the neural network may be one or more of a fully-connected structure, a convolutional structure, an RNN structure, an LSTM structure, a self-attention structure, or a transformer structure consisting of a self-attention network and a feedforward neural network.

In some examples, in a human-machine interaction scenario, if semantic information acquisition processing is not performed on a transmit end (for example, natural language or physical information transmission), the foregoing semantic acquiring unit needs to be deployed on a receive end, so that extended semantic information expected to be expressed by original information can be obtained, for example, one or more of extended semantic information such as emotion information, emphasis information, association information, prediction information, or different task priority information. That is, an input is original information received by a receive end (UE) from a base station, and an output is emotion information (or an emotion classification), emphasis information (or an importance classification), association information (or a classification, for example, the original information is associated with additional information other than the specific original information, and the additional information may be historical transmission information, public information that does not need to be transmitted, or the like), or prediction information (or a classification, for example, future moment information or decision information that can be predicted based on current original information content) that needs to be obtained.

In comparison with the wireless communications system as shown in FIG. 12, which mainly takes the transmission of original information into consideration, a communication requirement for more additional information can be met by employing a wireless communications system which is improved by deploying the foregoing semantic acquiring unit on a transmit end or a receive end. On the premise that both sides of communication are “human beings”, although transmission of only the original information is effective, the problem of interacting parties having different understandings of what is expected to be transmitted may also occur. With the development of technologies, in more Internet of Things and Internet of Intelligence scenarios, when both parties of communication start to update to “thing”, in “human-thing” and “thing-thing” transmission scenarios (that is, when at least one party of information transfer party or acquisition party is “thing”, even in relatively complex “human-thing” and “thing-thing” interaction), even lossless transmission of original information is not an optimal transmission scheme. On one hand, when at least one party in interaction is lack or weak in a capability of actively acquiring and understanding extended semantics (the extended semantics refers to complete information that the transmit end desires to send) other than original information, or the capability is not equal, a problem of incomplete and inaccurate information transmission may be caused. Through extended semantic acquisition processing, this problem can be avoided, so that the receive end acquires the complete information that the transmit end desires to transfer, thereby better supporting communication requirements for information integrity and transmission accuracy during an information transmission process in Internet of Things and Internet of Intelligence scenarios. On the other hand, when at least one party in the interaction adds redundancy information other than core semantic information to information to be exchanged (the core semantic information is key information that the receive end desires to receive, and the redundancy information is non-core semantic information), but the other party in the interaction does not need the redundancy information, a problem of redundant and inaccurate information transmission is caused. Through core semantic acquisition processing, this problem can be avoided, and therefore the receive end does not need to acquire the redundancy information sent by the transmit end, thereby better supporting a communication requirement for transmission accuracy during an information transmission process in Internet of Things and Internet of Intelligence scenarios, and improving transmission efficiency.

It should be noted that there are possibilities for the foregoing examples to combine with the foregoing embodiments of this application, and details are not described herein again.

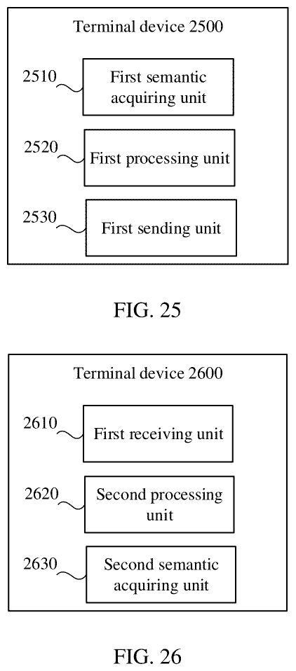

FIG. 25 is a schematic block diagram of a terminal device 2500 according to an embodiment of this application. The terminal device 2500 may include: a first semantic acquiring unit 2510, configured to perform semantic acquisition processing on an information source to obtain semantic information; a first processing unit 2520, configured to determine, based on the semantic information, first information to be transmitted; and a first sending unit 2530, configured to send the first information.

In a possible implementation, the first processing unit is configured to obtain, in a manner including at least one of the following, the first information to be transmitted:
obtaining the first information through encoding and modulating the semantic information; or
obtaining the first information through encoding, modulating, and encrypting the semantic information.

In a possible implementation, the first semantic acquiring unit is configured to perform extended semantic acquisition processing on the information source to obtain extended semantic information.

In a possible implementation, the first semantic acquiring unit is configured to perform core semantic acquisition processing on the information source to obtain core semantic information.

In a possible implementation, the first semantic acquiring unit is configured to: perform extended semantic acquisition processing on the information source to obtain extended semantic information; perform core semantic acquisition processing on the information source to obtain core semantic information; and obtain combined semantic information based on the extended semantic information and the core semantic information.

In a possible implementation, the first semantic acquiring unit is configured to obtain the extended semantic information in a manner including at least one of the following:
inputting the information source into a first trained network model to obtain at least one of emotion information, emphasis information, association information, prediction information, or different task priority information; or
inputting the information source into a second trained network model to obtain at least one of different emotion information classifications, different emphasis information classifications, different association information supplements, different prediction information supplements, or different task priority information supplements.

In a possible implementation, the extended semantic information includes at least one of emotion information, emphasis information, association information, prediction information, or different task priority information.

In a possible implementation, the following is further included: classifying each piece of information in the extended semantic information based on different classifications, and using corresponding identifier information as a classification identifier; and establishing a mapping relationship based on the classification identifier and a corresponding classification description.

In a possible implementation, the first semantic acquiring unit is configured to input the information source into a third trained network model to obtain the core semantic information.

The terminal device 2500 in this embodiment of this application can implement a corresponding function of the terminal device in the foregoing method embodiment. As for procedures, functions, implementations, and beneficial effects corresponding to modules (submodules, units, components, or the like) in the terminal device 2500, reference may be made to the corresponding description of the foregoing method embodiment. Details are not described herein again. It should be noted that functions as described with respect to the modules (submodules, units, components, or the like) in the terminal device 2500 in this embodiment of this application may be implemented by different modules (submodules, units, components, or the like), or may be implemented by a same module (submodule, unit, component, or the like).

FIG. 26 is a schematic block diagram of a terminal device 2600 according to an embodiment of this application. The terminal device 2600 may include: a first receiving unit 2610, configured to receive second information; a second processing unit 2620, configured to restore an information source from the second information; and a second semantic acquiring unit 2630, configured to perform semantic acquisition processing on the information source to obtain semantic information.

In a possible implementation, the second processing unit is configured to restore the information source in a manner including at least one of the following:
obtaining the information source through decoding and demodulating the second information; or
obtaining the information source through decoding, demodulating, and decrypting the second information.

In a possible implementation, the second semantic acquiring unit is configured to perform extended semantic acquisition processing on the information source to obtain extended semantic information.

In a possible implementation, the second semantic acquiring unit is configured to perform core semantic acquisition processing on the information source to obtain core semantic information.

In a possible implementation, the second semantic acquiring unit is configured to: perform extended semantic acquisition processing on the information source to obtain extended semantic information; perform core semantic acquisition processing on the information source to obtain core semantic information; and obtain combined semantic information based on the extended semantic information and the core semantic information.

In a possible implementation, the second semantic acquiring unit is configured to obtain the extended semantic information in a manner including at least one of the following:
inputting the information source into a fourth trained network model to obtain at least one of emotion information, emphasis information, association information, prediction information, or different task priority information; or
inputting the information source into a fifth trained network model to obtain at least one of different emotion information classifications, different emphasis information classifications, different association information supplements, different prediction information supplements, or different task priority information supplements.

In a possible implementation, the extended semantic information includes at least one of emotion information, emphasis information, association information, prediction information, or different task priority information.

In a possible implementation, the apparatus further includes a third processing unit, configured to: classify each piece of information in the extended semantic information based on difference classifications, and use corresponding identifier information as a classification identifier; and establish a mapping relationship based on the classification identifier and a corresponding classification description.

In a possible implementation, the second semantic acquiring unit is configured to input the information source into a sixth trained network model to obtain the core semantic.

The terminal device 2600 in this embodiment of this application can implement a corresponding function of the terminal device in the foregoing method embodiment. As for procedures, functions, implementations, and beneficial effects corresponding to modules (submodules, units, components, or the like) in the terminal device 2600, reference may be made to the corresponding description of the foregoing method embodiment. Details are not described herein again. It should be noted that functions as described with respect to modules (submodules, units, components, or the like) in the terminal device 2600 in this embodiment of this application may be implemented by different modules (submodules, units, components, or the like), or may be implemented by a same module (submodule, unit, component, or the like).

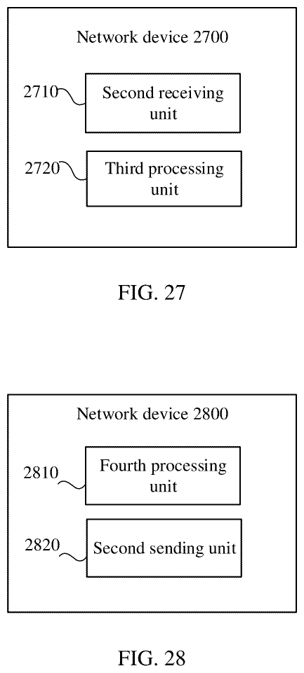

FIG. 27 is a schematic block diagram of a network device according to an embodiment of this application. The network device 2700 may include: a second receiving unit 2710, configured to receive first information; and a third processing unit 2720, configured to restore semantic information from the first information, where the semantic information is information obtained by performing semantic acquisition processing on an information source on the side of a terminal device.

In a possible implementation, the third processing unit is configured to restore the semantic information from the first information in a manner including at least one of the following:
obtaining the semantic information through decoding and demodulating the first information; or
obtaining the semantic information through decoding, demodulating, and decrypting the first information.

In a possible implementation, the semantic information includes at least one of extended semantic information or core semantic information.

In a possible implementation, the extended semantic information includes at least one of emotion information, emphasis information, association information, prediction information, or task priority information.

In a possible implementation, the extended semantic information includes at least one of an emotion information classification, an emphasis information classification, an association information supplement, a prediction information supplement, or a task priority information supplement.

In a possible implementation, the core semantic information includes at least one of a behavior, an action, an instruction, data, or a command.

The network device 2700 in this embodiment of this application can implement a corresponding function of the network device in the foregoing method embodiment. As for procedures, functions, implementations, and beneficial effects corresponding to modules (submodules, units, components, or the like) in the network device 2700, reference may be made to the corresponding description of the foregoing method embodiment. Details are not described herein again. It should be noted that functions as described with respect to modules (submodules, units, components, or the like) in the network device 2700 in this embodiment of this application may be implemented by different modules (submodules, units, components, or the like), or may be implemented by a same module (submodule, unit, component, or the like).

FIG. 28 is a schematic block diagram of a network device according to an embodiment of this application. The network device 2800 includes: a fourth processing unit 2810, configured to determine, based on an information source, second information to be transmitted, where the information source includes semantic information on which semantic acquisition processing is to be performed; and a second sending unit 2820, configured to send the second information.

In a possible implementation, the fourth processing unit is configured to determine, in a manner including at least one of the following, the second information to be transmitted:
obtaining the second information through encoding and modulating the information source; or
obtaining the second information through encoding, modulating, and encrypting the information source.

In a possible implementation, the semantic information includes at least one of extended semantic information or core semantic information.

In a possible implementation, the extended semantic information includes at least one of emotion information, emphasis information, association information, prediction information, or task priority information.

In a possible implementation, the extended semantic information includes at least one of an emotion information classification, an emphasis information classification, an association information supplement, a prediction information supplement, or a task priority information supplement.

In a possible implementation, the core semantic information includes at least one of a behavior, an action, an instruction, data, or a command.

The network device 2800 in this embodiment of this application can implement a corresponding function of the network device in the foregoing method embodiment. As for procedures, functions, implementations, and beneficial effects corresponding to modules (submodules, units, components, or the like) in the network device 2800, reference may be made to the corresponding description of the foregoing method embodiment. Details are not described herein again. It should be noted that functions as described with respect to modules (submodules, units, components, or the like) in the network device 2800 in this embodiment of this application may be implemented by different modules (submodules, units, components, or the like), or may be implemented by a same module (submodule, unit, component, or the like).

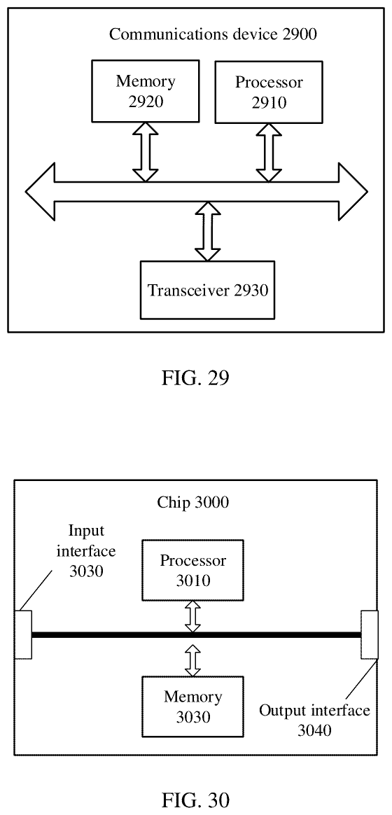

FIG. 29 is a schematic structural diagram of a communications device 2900 according to an embodiment of this application. The communications device 2900 includes a processor 2910, and the processor 2910 may invoke a computer program from a memory and run the computer program to cause the communications device 2900 to implement a method in embodiments of this application.

Optionally, the communications device 2900 may further include a memory 2920. The processor 2910 may invoke a computer program from the memory 2920 and run the computer program to cause the communications device 2900 to implement a method in embodiments of this application.

The memory 2920 may be a separate component independent of the processor 2910, or may be integrated into the processor 2910.

Optionally, the communications device 2900 may further include a transceiver 2930. The processor 2910 may control the transceiver 2930 to communicate with another device. Specifically, the transceiver 2930 may send information or data to the other device, or receive information or data sent by the other device.

The transceiver 2930 may include a transmitter and a receiver. The transceiver 2930 may further include an antenna, and there may be one or more antennas.

Optionally, the communications device 2900 may be a terminal device used as a transmit end in an embodiment of this application, and the communications device 2900 may implement corresponding procedures implemented by the terminal device in the methods in embodiments of this application. For brevity, details are not described herein again.

Optionally, the communications device 2900 may be a terminal device used as a receive end in an embodiment of this application, and the communications device 2900 may implement corresponding procedures implemented by the terminal device in the methods in embodiments of this application. For brevity, details are not described herein again.

FIG. 30 is a schematic structural diagram of a chip 3000 according to an embodiment of this application. The chip 3000 includes a processor 3010, and the processor 3010 may invoke a computer program from a memory and run the computer program to implement a method in embodiments of this application.

Optionally, the chip 3000 may further include a memory 3026. The processor 3010 may invoke a computer program from the memory 3026 and run the computer program, so as to implement the method executed by the terminal device or the network device in embodiments of this application.

The memory 3026 may be a separate component independent of the processor 3010, or may be integrated into the processor 3010.

Optionally, the chip 3000 may further include an input interface 3030. The processor 3010 may control the input interface 3030 to communicate with another device or chip, and specifically, may obtain information or data sent by the other device or chip.

Optionally, the chip 3000 may further include an output interface 3040. The processor 3010 may control the output interface 3040 to communicate with another device or chip, and specifically, may output information or data to the other device or chip.

Optionally, the chip may be applied to a terminal device used as a transmit end in an embodiment of this application, and the chip may implement corresponding procedures implemented by the terminal device in the methods in embodiments of this application. For brevity, details are not described herein again.

Optionally, the chip may be applied to a terminal device used as a receive end in an embodiment of this application, and the chip may implement corresponding procedures implemented by the terminal device in the methods in embodiments of this application. For brevity, details are not described herein again.

Chips applied to the terminal device used as the transmit end and the terminal device used as the receive end may be a same chip or different chips.

It should be understood that the chip mentioned in this embodiment of this application may also be referred to as a system-level chip, a system chip, a chip system, or a system-on-chip.

The foregoing mentioned processor may be a general-purpose processor, a digital signal processor (DSP), a field programmable gate array (FPGA), an application-specific integrated circuit (ASIC) or another programmable logic device, a transistor logic device, a discrete hardware component, or the like. The general-purpose processor mentioned above may be a microprocessor, or may be any conventional processor.

The memory mentioned above may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM).

It should be understood that, by way of example but not limitative description, for example, the memory in this embodiment of this application may alternatively be a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), a direct rambus random access memory (DR RAM), or the like. In other words, the memory in this embodiment of this application includes but is not limited to these memories and any memory of another proper type.

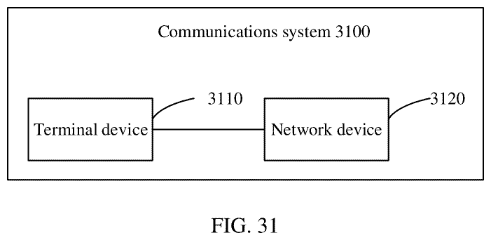

FIG. 31 is a schematic block diagram of a communications system 3100 according to an embodiment of this application. The communications system 3100 includes a terminal device 3110 used as a transmit end and a network device 3120 used as a receive end. The receive end may be another terminal device, and details are not described again. The terminal device 3110 used as the transmit end may include: a first semantic acquiring unit, configured to perform semantic acquisition processing on an information source to obtain semantic information; a first processing unit, configured to obtain, based on the semantic information, first information to be transmitted; and a first sending unit, configured to send the first information. The network device 3120 used as the receive end may include: a second receiving unit, configured to receive first information; and a third processing unit, configured to restore semantic information from the first information, where the semantic information is information obtained by performing semantic acquisition processing on an information source on the side of a terminal device. The terminal device 3110 used as the transmit end may be configured to implement a corresponding encoding-based semantic communication function implemented by the terminal device in the foregoing method, and the network device 3120 used as the receive end may be configured to implement a corresponding decoding-based semantic communication function implemented by the network device in the foregoing method. For brevity, details are not described herein again.

All or some of the foregoing embodiments may be implemented by using software, hardware, firmware, or any combination thereof. When the software is used to implement embodiments, all or some of embodiments may be implemented in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, wireless, and microwave) manner. The computer-readable storage medium may be any available medium accessible by a computer or a data storage device such as a server or a data center that integrates one or more available media. The available medium may be a magnetic medium (for example, a floppy disk, a hard disk, or a magnetic tape), an optical medium (for example, a DVD), a semiconductor medium (for example, a solid state disk (SSD)), or the like.

It should be understood that, in the embodiments of this application, sequence numbers of the foregoing processes do not mean execution sequences. The execution sequences of the processes should be determined according to functions and internal logic of the processes, and should not be construed as any limitation on the implementation processes of the embodiments of this application.

It may be clearly understood by a person skilled in the art that, for the purpose of convenient and brief description, for a detailed working process of the foregoing system, apparatus, and unit, reference may be made to corresponding processes in the foregoing method embodiments, and details are not described herein again.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of and the claims.

1. A terminal device, comprising a processor and a memory, wherein the memory is configured to store a computer program, and the processor is configured to invoke and run the computer program stored in the memory, to cause the terminal device to perform:
performing semantic acquisition processing on an information source to obtain semantic information;
determining, based on the semantic information, first information to be transmitted; and
sending the first information.

2. The terminal device according to claim 1, wherein the determining, based on the semantic information, first information to be transmitted comprises at least one of following:
obtaining the first information through encoding and modulating the semantic information; or
obtaining the first information through encoding, modulating, and encrypting the semantic information.

3. The terminal device according to claim 1, wherein the performing semantic acquisition processing on an information source to obtain semantic information comprises:
performing extended semantic acquisition processing on the information source to obtain extended semantic information.

4. The terminal device according to claim 1, wherein the performing semantic acquisition processing on an information source to obtain semantic information comprises:
performing core semantic acquisition processing on the information source to obtain core semantic information.

5. The terminal device according to claim 1, wherein the performing semantic acquisition processing on an information source to obtain semantic information comprises:
performing extended semantic acquisition processing on the information source to obtain extended semantic information;
performing core semantic acquisition processing on the information source to obtain core semantic information; and
obtaining combined semantic information based on the extended semantic information and the core semantic information.

6. The terminal device according to claim 3, wherein the performing extended semantic acquisition processing on the information source to obtain extended semantic information comprises at least one of following:
inputting the information source into a first trained network model to obtain at least one of emotion information, emphasis information, association information, prediction information, or task priority information; or
inputting the information source into a second trained network model to obtain at least one of an emotion information classification, an emphasis information classification, an association information supplement, a prediction information supplement, or a task priority information supplement.

7. The terminal device according to claim 3, wherein the extended semantic information comprises at least one of emotion information, emphasis information, association information, prediction information, or task priority information.

8. The terminal device according to claim 7, wherein the processor is further configured to invoke and run the computer program stored in the memory, to cause the terminal device to perform:
classifying each piece of information in the extended semantic information, and using corresponding identifier information as a classification identifier; and
establishing a mapping relationship based on the classification identifier and a corresponding classification description.

9. The terminal device according to claim 4, wherein the performing core semantic acquisition processing on the information source to obtain core semantic information comprises:
inputting the information source into a third trained network model to obtain the core semantic information.

10. A terminal device, comprising a processor and a memory, wherein the memory is configured to store a computer program, and the processor is configured to invoke and run the computer program stored in the memory, to cause the terminal device to perform:
receiving second information;
restoring an information source from the second information; and
performing semantic acquisition processing on the information source to obtain semantic information.

11. The terminal device according to claim 10, wherein the restoring an information source from the second information comprises at least one of following:
obtaining the information source through decoding and demodulating the second information; or
obtaining the information source through decoding, demodulating, and decrypting the second information.

12. The terminal device according to claim 10, wherein the performing semantic acquisition processing on the information source to obtain semantic information comprises:
performing extended semantic acquisition processing on the information source to obtain extended semantic information.

13. The terminal device according to claim 10, wherein the performing semantic acquisition processing on the information source to obtain semantic information comprises:
performing core semantic acquisition processing on the information source to obtain core semantic information.

14. The terminal device according to claim 10, wherein the performing semantic acquisition processing on the information source to obtain semantic information comprises:
performing extended semantic acquisition processing on the information source to obtain extended semantic information;
performing core semantic acquisition processing on the information source to obtain core semantic information; and
obtaining combined semantic information based on the extended semantic information and the core semantic information.

15. The terminal device according to claim 12, wherein the performing extended semantic acquisition processing on the information source to obtain extended semantic information comprises at least one of following:
inputting the information source into a fourth trained network model to obtain at least one of emotion information, emphasis information, association information, prediction information, or task priority information; or
inputting the information source into a fifth trained network model to obtain at least one of an emotion information classification, an emphasis information classification, an association information supplement, a prediction information supplement, or a task priority information supplement.

16. The terminal device according to claim 12, wherein the extended semantic information comprises at least one of emotion information, emphasis information, association information, prediction information, or task priority information.

17. The terminal device according to claim 16, wherein the processor is further configured to invoke and run the computer program stored in the memory, to cause the terminal device to perform:
classifying each piece of information in the extended semantic information, and using corresponding identifier information as a classification identifier; and
establishing a mapping relationship based on the classification identifier and a corresponding classification description.

18. The terminal device according to claim 13, wherein the performing core semantic acquisition processing on the information source to obtain core semantic information comprises:
inputting the information source into a sixth trained network model to obtain the core semantic information.

19. A network device, comprising a processor and a memory, wherein the memory is configured to store a computer program, and the processor is configured to invoke and run the computer program stored in the memory, to cause the network device to perform:
receiving first information; and
restoring semantic information from the first information,
wherein the semantic information is information obtained by performing semantic acquisition processing on an information source on the side of a terminal device.

20. The network device according to claim 19, wherein the restoring semantic information from the first information comprises at least one of following:
obtaining the semantic information through decoding and demodulating the first information; or
obtaining the semantic information through decoding, demodulating, and decrypting the first information.
